(19) United States
(12) Patent Application Publication
(10) Pub. No.: US 2008/0056871 A1
(43) Pub. Date: Mar. 6, 2008

(54) Lift dolly

(76) Inventors: Edwin M. Morgan, Havana, FL (US); David W. Mercaldi, (US)

Correspondence Address: BERENATO, WHITE & STAVISH, LLC, 6550 ROCK SPRING DRIVE, SUITE 240, BETHESDA, MD, 20817, US

(21) Appl. No.: 11/822,693

(22) Filed: Jul. 9, 2007

Related U.S. Application Data
(60) Provisional application No. 60/819,405, filed on Jul. 10, 2006.

(51) Int. Cl. B62B 5/06; B62B 3/00

(52) U.S. Cl. 414/495; 414/800

(57) ABSTRACT

A lift dolly is provided for selectively lifting and transporting an object, such as a power tool mounted on a stand. According to an embodiment, the lift dolly features a frame structure including a wheel system, movable supporting elements, and a foot-actuation member. The supporting elements are connected to the frame structure for lifting and lowering an object loaded on the movable supporting elements between a lowered position, in which the object rests on the ground, and a lifted position, in which the object is supported above the ground and movable by rolling the wheel system. The foot-actuation member is operatively connected to at least one of the supporting elements for moving the supporting elements between the lowered and lifted positions in response to downward pressure applied to the foot-actuation member by a foot of an operator.

### CROSS-REFERENCE TO RELATED APPLICATION

This application claims the benefit of priority under 35 U.S.C. §119 of provisional application 60/819,405 filed Jul. 10, 2006, entitled “Lift Dolly”, the complete disclosure of which is incorporated herein by reference.

### FIELD OF THE INVENTION

This invention relates to a lift dolly which is adapted to lift and transport stand-mounted power tools, as well as other objects. In particular embodiments, the invention relates to a lift dolly which permits the operator to lift the tool or object to be transported by simply stepping onto a foot-receiving surface thereby forcing the dolly's wheel system downward and into a position for supporting and transporting the stand-mounted tool or object.

### BACKGROUND OF THE INVENTION

Lift dollies are known for lifting and moving bulky machinery, plate glass, and the like. In such dollies, a hand-actuated hydraulic jack typically raises and lowers forks for lifting the machinery, after which the dolly and machinery may together be rolled along the floor/ground by way of wheels mounted on the dolly.

Unfortunately, such dollies, while useful in transporting crates, plate glass, etc., are not adapted for convenient and repeated lifting and/or transporting items such as stand-mounted power tools and the like due to the shape defined by legs of such stands. Additionally, conventional lift dollies usually are relatively large and bulky, consuming undue space and interfering with the proper operation of the power tool when the tool is mounted on the dolly.

In view of the above, it is apparent that there exists a need in the art for a lift dolly capable of lifting and transporting, with little effort, stand-mounted objects, such as power tools. Preferably, such a dolly should be simplistic, easy to use, and cost-effective to manufacture. Also preferably, the dolly should permit for proper usage of power tools mounted on the lift dollies.

### SUMMARY OF THE INVENTION

In accordance with the principles of the invention as embodied and described herein, a first aspect of the invention provides a lift dolly for selectively lifting and transporting an object, such as a power tool mounted on a stand. The lift dolly features a frame structure including a wheel system, movable supporting elements, and a foot-actuation member. The supporting elements are movably connected to the frame structure for lifting and lowering an object loaded on the movable supporting elements between a lowered position, in which the object rests on the ground, and a lifted position, in which the object is supported above the ground and movable by rolling the wheel system. The foot-actuation member is operatively connected to at least one of the supporting elements for moving at least one of the supporting elements between the lowered and lifted positions in response to downward pressure applied to the foot-actuation member by a foot of an operator. A lever is operatively connected to the foot-actuation member for pivoting downward in response to the downward pressure applied to the foot-actuation member by the foot of the operator. The operative connection causes a shaft to undergo rotational movement as the lever pivots downward. Rotation of the shaft causes the supporting element(s) to move between the lowered and lifted positions.

According to a second aspect of the invention, a method is provided for lifting and transporting an object. The method features providing the lift dolly of the first aspect of the invention, loading an object on the supporting elements, and applying a downward foot-activating motion to the foot-actuation pedal to move the supporting elements from the lowered position to the lifted position.

A third aspect of the invention provides a lift dolly for selectively lifting and transporting an object. The lift dolly features a frame structure including a wheel system, an actuation member, and movable first and second supporting elements connected to the frame structure for lifting and lowering an object loaded on the supporting elements between a lowered position, in which the object rests on the ground, and a lifted position, in which the object is supported above the ground and movable by rolling the wheel system. The actuation member is operatively connected to the first supporting element for moving the first supporting element between the lowered position and the lifted position. The actuation member has a latent relationship with the second supporting element such that operative connection between the actuation member and the second supporting element is active when the object is loaded on the lift dolly, but inactive when the lifting dolly is unoccupied by the object.

According to a fourth aspect of the invention, a method is provided for lifting and transporting an object. The method features providing the lift dolly of the third aspect of the invention, loading an object on the supporting elements, and applying a downward foot-activating motion to the actuation member to move the supporting elements from the lowered position to the lifted position.

A fifth aspect of the invention provides a lift dolly for selectively lifting and transporting an object, the lift dolly featuring a frame structure including a wheel system, movable supporting elements, an actuation member, a locking mechanism, and a height adjustment feature. The supporting elements are connected to the frame structure for lifting and lowering an object loaded on the supporting elements between a lowered position, in which the object rests on the ground, and a lifted position, in which the object is supported above the ground and movable by rolling the wheel system. The actuation member is operatively connected to at least one of the supporting elements for moving the supporting elements between the lowered and lifted positions in response to activation by an operator. The locking mechanism retains the supporting elements in the lifted position, and the height adjustment feature permits selective setting of the distance between the object and the ground when the locking mechanism retains the supporting elements in the lifted position.

According to a sixth aspect of the invention, a method is provided for lifting and transporting an object. The method features providing the lift dolly of the fifth aspect of the invention, loading an object on the supporting elements, and applying a downward foot-activating motion to the actuation member to move the supporting elements from the lowered position to the lifted position.

A seventh aspect of the invention provides a lift dolly for selectively lifting and transporting an object, comprising a frame structure with a wheel system, movable supporting elements, and an actuatable arm. The supporting elements are movably connected to the frame structure for lifting and moving an object loaded on the supporting elements between a stationary lowered position, in which at least a portion of the weight of the object is not supported by the wheel system, and a lifted position, in which the object is supported above the ground and movable by rolling the wheel system. The actuatable arm is movable in response to pressure applied by an operator. An operative connection between the actuatable arm and at least one of the supporting elements is constructed and arranged for moving the at least one of the supporting elements between lowered and lifted positions in response to pressure applied to the arm by the operator. The operative connection comprises a lever which pivots downward in response to the downward pressure applied to the arm by the operator, a shaft which undergoes rotational movement as the lever pivots downward, and linking arms operatively connecting the shaft to the at least one of the supporting elements for moving the at least one supporting element between the lowered and lifted positions as the shaft rotates.

According to an eighth aspect of the invention, a method is provided for lifting and transporting an object. The method features providing the lift dolly of the seventh aspect of the invention, loading an object on the supporting elements, and applying a downward foot-activating motion to the actuatable arm to move the supporting elements from the lowered position to the lifted position.

Other aspects of the invention include methods of making and operating the lift dolly, and additional embodiments of the lift dolly described below.

### BRIEF DESCRIPTION OF THE DRAWINGS

The accompanying drawings are incorporated in and constitute a part of the specification. The drawings, together with the general description given above and the detailed description of the preferred embodiments and methods given below, serve to explain the principles of the invention. In such drawings:

FIG. 1 is a perspective view of a lift dolly according to an embodiment of this invention, in its locked/lifting position;

FIG. 2 is a partially cut-away side view of the lift dolly of FIG. 1, in its unlocked/lowered position for resting a stand-mounted power tool (showed in phantom) on the ground;

FIG. 3 is a partially cut-away side view of the lift dolly of FIG. 1, in its locked/lifting position for raising the stand-mounted power tool (shown in phantom) above the ground;

FIG. 4 is an enlarged, partially cut-away side view of a height adjustment feature of the embodied lift dolly, with the stand-mounted power tool shown in phantom; and

FIG. 5 is perspective view of the lift dolly of FIG. 1 in its locked/lifting position, with the stand-mounted power tool raised above the ground.

### DETAILED DESCRIPTION OF THE PREFERRED EMBODIMENTS AND PREFERRED METHODS OF THE INVENTION

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods.

Referring to the figures, a lift dolly according to an embodiment of the invention is generally designated by reference numeral 10. Lift dolly 10 features a rigid, generally flat U-shaped frame structure comprising elongated side frame members 12, 14 opposite to one another. Side frame members 12, 14 are connected to a rear end frame member or cross bar 16, which is illustrated as having a cylindrical configuration. Side frame members 12, 14 may be hollow (as illustrated) or solid. Rear end frame member 16 is preferably hollow with a rotatable shaft 18 fitted therein. A retention rod or pin 42 is fixedly secured to and extends outward from the exterior face of side frame member 14.

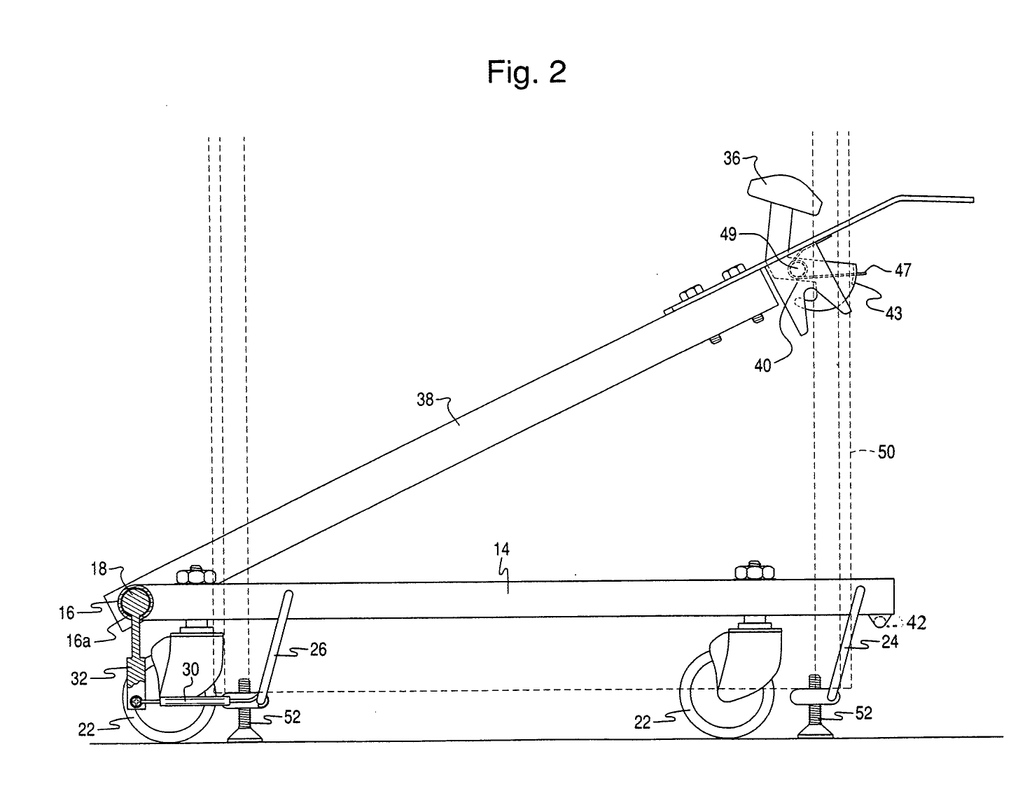

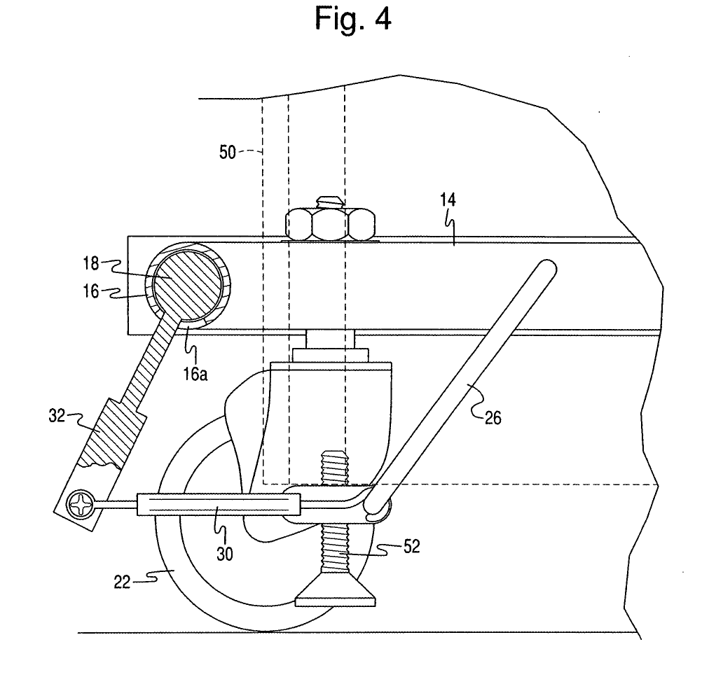

The frame structure is oriented in substantially parallel relationship to the ground in both the unlocked/lowered position and its locked/raised position. The frame structure components may be made of any suitable material, such as metal, plastics, and/or composites. The front end portion of the U-shaped frame structure is open, i.e., a frame member does not extend between the front ends of side frame members 12, 14. This opening at the front of the frame structure facilitates substantially unimpeded loading and unloading of an object 50 (FIGS. 2-5) onto lift dolly 10, and avoids potential interference with front access doors or panels that may be present on machine-based cabinetry.

Lift dolly 10 includes a wheel system comprising a plurality of mounts 20 located at the respective corners of the frame structure. Castors 22 are affixed to and extend downward from mounts 20, respectively. As illustrated the wheel system contains four castors 22, each pivotal about a respective vertical axis. It should be understood that a lesser or greater number of castors 22 may be present. Alternatively, other types of known wheel systems may be used in addition to or in lieu of castors 22. For example, the front set of castors 22 and/or the rear set of castors 22 may be replaced with a single elongated rotating cylinder or a pair of wheels on a common axel. In the illustrated embodiment, the incorporation of a fully castored wheel system, as opposed to a fixed-axel wheel system capable of rolling in a single direction, advantageously permits omni-directional mobility and enhances maneuverability for the object 50 loaded on lift dolly 10.

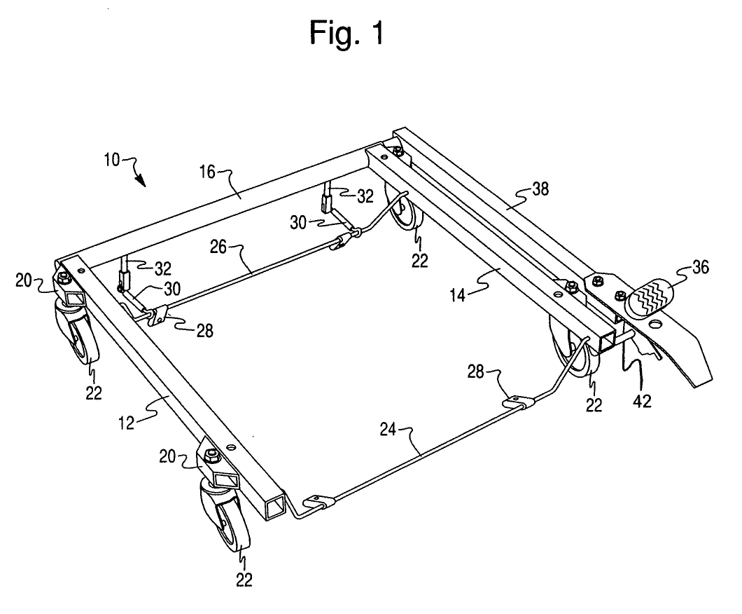

Support elements 24, 26 extend perpendicularly to side frame members 12, 14 and generally parallel to rear end frame member 16. Support element 24 is positioned forward, i.e., in proximity to the front of lift dolly 10, whereas support element 26 is positioned rearward, in proximity to rear end frame member 16. Forward and rearward support elements 24, 26 as illustrated are generally identical in shape to one another, each resembling a crank shape with a central carriage region and flared end portions extending upwards and terminating with laterally outward extending stems. The central carriage regions of elements 24, 26 are located in a common horizontal plane in the locked/lifting position depicted in FIG. 1. The opposite ends of forward support element 24 are pivotally received in apertures (unnumbered) of side frame members 12, 14, respectively. It should be understood that apertures may be replaced with recesses, slots, or any other receiving or retaining feature that will permit the pivotal movement of support element 24. The opposite ends of rearward support element 26 are similarly connected to side frame members 12, 14, respectively, for permitting pivotal movement of rearward support element 26. As will be described in greater detail below, forward and rearward support elements 24, 26 are pivotal relative to the frame structure to permit lifting and lowering of object 50 relative to the frame structure and castors 22. Although not shown, suitable bearings and journals may be used to facilitate pivotal movement of forward and rearward support elements 24, 26.

Forward and rearward support elements 24, 26 each carry contact members (anchor brackets) 28 constructed and arranged to retain object 50 placed on lift dolly 10. The embodiment depicted in the drawings contains four (4) contact members 28, although fewer or more may be used. Contact members 28 optionally may have through holes or other features for permitting fastening of contact members 28 to the bottom or legs of object 50. Contact members 28 are preferably slidable lengthwise along support elements 24, 26 to allow accommodation of different size objects 50. In the illustrated embodiment, object 50 includes legs/feet 52 penetrating corresponding throughholes of contact members 28. Legs 52 mate (e.g., via screw threaded interfaces, locking pins, bolts, etc.) with receptacle areas in the bottom of object 50.

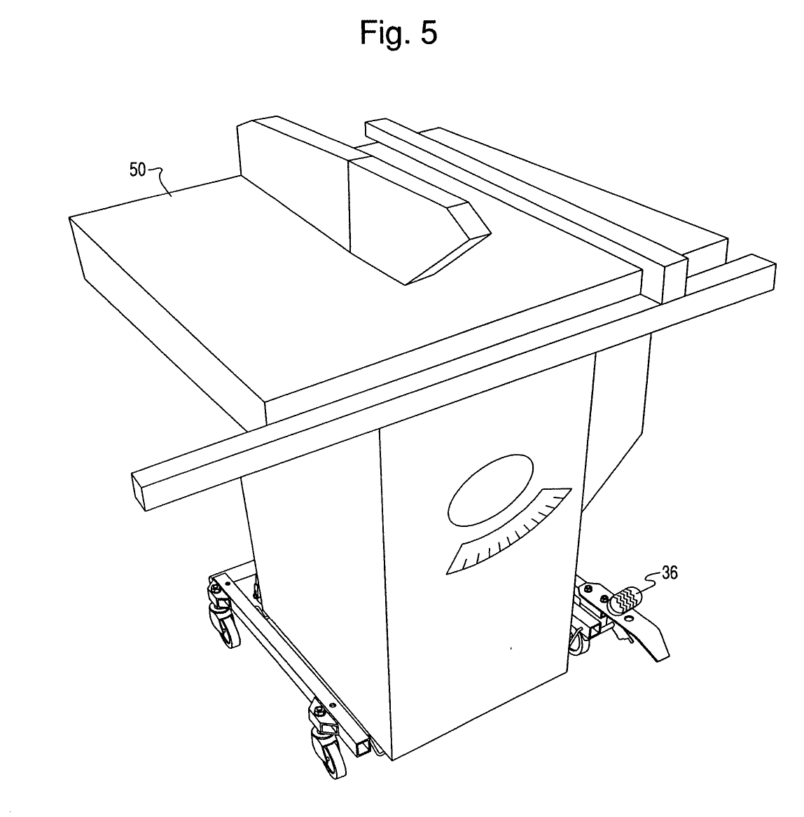

For the purpose of illustration, in FIG. 5 a stand-mounted power tool in the form of a table saw has been selected as object 50. Other power tools such as drills, lathes, etc. may also be mounted on lift dolly 10. It is also possible to use lift dolly 10 for lifting and lowering objects other than power tools. For example, dolly 10 can be advantageously used in connection with or built into a wide variety of other devices such as tables, workbenches, medical equipment, chairs (occupied or unoccupied), engine lifts, coolers, filing cabinets, and copiers and other office equipment to facilitate lifting and/or transport thereof.

Linking arms 30 are laterally spaced from one another and are in generally parallel relationship to the ground and to one another. The forward ends of linking arms 30 are pivotally connected to rearward support element 26. The rearward ends of linking arms 30 are pivotally connected to crank arms 32, respectively. Crank arms 32 connect to and extend radially downward from rotatable shaft 18 housed in rear end frame member 16. A close inspection of FIGS. 2-4 reveals that rear end frame member 16 has downward-facing crescent-shaped slots 16a through which crank arms 32 extend.

Linking arms 30 each optionally have an adjustable length. Adjustment to the length of linking arms 30 permits selective control of the lift height, i.e., the distance between object 50 and the ground when lift dolly 10 is in the locked/raised position. In the illustrated embodiment, each linking arm 30 comprise a turnbuckle having an eyelet engaging its corresponding crank arm 32 and a hook engaging support element 26. Other components for varying the length between crank arms 32 and support element 26 may be used in lieu of turnbuckles, such as piston-rod assemblies.

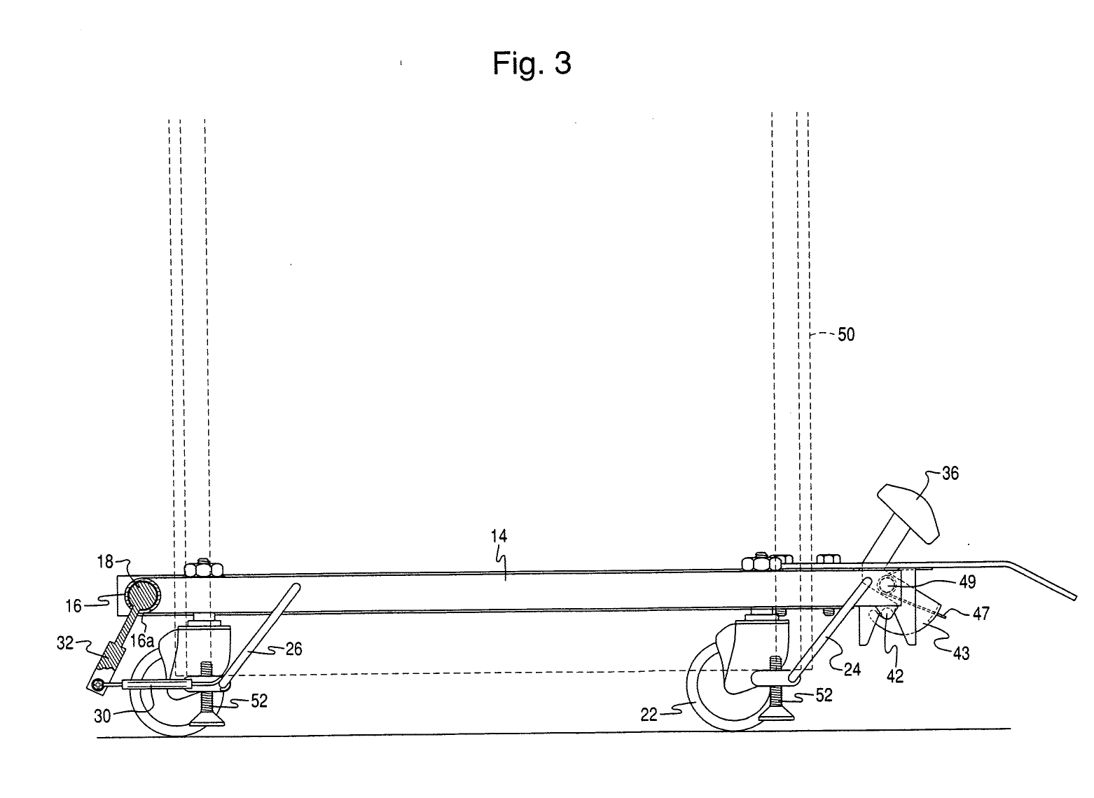

Lift dolly 10 further includes a latching mechanism for retaining lift dolly 10 in its raised/mobile position. The latching mechanism includes a foot-receiving surface or pedal 36, such as a treadle, mounted on pivotal lever 38. The latching mechanism further includes a latch mount 40 (best shown in FIG. 2) extending downward below and fixedly attached to lever 38. The bottom edge of latch mount 40 defines an inverted V-shaped recess. As best shown in FIG. 3, in the locked/lifting position retention rod 42 is received in the V-shaped recess of latch mount 40.

A pivot joint 49 attaches a cam 43 to latch mount 40. Cam 43 is operatively connected to pedal 36. A hook-shaped edge portion of cam 43 defines a groove which cooperates with the V-shaped recess of latch mount 40 to capture retention rod 42, i.e., rod 42 is shaped and dimensioned for capture between cam 43 and the recess-defining edge of latch mount 40. A torsion spring 47 mounted on pivot joint 49 has an upper end connected to the bottom surface of lever 38, and a lower end received in a slot of cam 43. Torsion spring 47 applies a biasing force to cam 43 to urge capture of retention rod 42 by cam 43, thereby maintaining the latching mechanism in a locked position. The biasing force of torsion spring 47 may be overcome be depressing pedal 36, causing cam 43 to rotate about pivot joint 49 to permit release of retention rod 42 from its locked position.

It will be appreciated that the illustrated and discussed latching mechanism is exemplary and the invention is not limited thereto. Other known latching mechanisms may be used instead.

The rear end of lever 38 is affixed to pivot shaft 18 housed in rear end frame member 16. Upward and downward movements of lever 38 impart rotational movement to pivot shaft 18, which rotates with rear end frame member 16. As lever 38 is urged downward, e.g., by the depressing force of an operator's foot, the rotational movement imparted to shaft 18 pivots crank arms 32 rearward. The pivoting movement of crank arms 32 pulls the attached linking arm 30 rearward, which in turn actively pulls support element 26 attached to linking arms 30 rearward. Because support element 26 is pivotally mounted at its opposite ends to side frame members 14, 16, the carriage portion of support element 26 follows an arcuate rearward and upward path as lift dolly 10 is shifted into its locked/raised position. The rear of object 50 is thereby raised by support element 26.

In the illustrated embodiment, an active operative connection between support element 24 and lever 38 does not exist when the frame structure of lift dolly 10 is unoccupied by a power tool or other object 50 to be transported. As a result, in its unoccupied state (shown in FIG. 1) upward and downward movements of lever 38 cause cradle element 26 to pivot, but do not cause cradle element 24 to pivot relative to the frame structure. This relationship between lever 38 and cradle element 24 when the cradle elements 24, 26 are unoccupied is referred to herein as an inactive state.

Cradle element 24 may be transformed into an active state relative to lever 38 by loading object 50 onto cradle elements 24, 26 to establish a passive connection between cradle elements 24, 26. Object 50 (e.g. stand-mounted power tool) is loaded onto support elements 24, 26 preferably from the front open access area of the frame structure. Optionally, forward support element 24 is detachable from the frame structure for permitting the U-shaped frame structure to receive object 50. Each contact member or anchor plate 28 is secured to object 50 in any appropriate fashion. In one preferred yet optional embodiment, each foot 52 of object 50 includes a screw-threaded post or leg that extends upward, passing through the through hole of anchor plate 28 and mating with a corresponding screw-threaded aperture or recess defined in the bottom of object 50.

With lever 38 in its unlatched state, the weight of object 50 causes the frame structure of lift dolly 10 to be shifted into its lowered position so that most if not substantially all of the weight of object 50 is supported by feet 52 resting on the ground. Although in this lowered position castor wheels 22 may contact the ground, castor wheels 22 do not bear the full weight of object 50. Feet 52 serve as the primary support for object 50 in the lowered position, and frictional contact between feet 52 and the ground prevents castors 22 from rolling object 50 across the ground. When lift dolly 10 is in its lowered state, object 50 remains stationary on the ground with sufficient stability to permit operational use of object 50, for example, if object 50 is a table saw cutting operations may be properly performed while the table saw is loaded on lift dolly 10 in its lowered position. Preferably, proper operation of object 50 (e.g., power tool) is not impeded by lift dolly 10 in this lowered state.

To raise object 50 above the ground so that the full weight of object 50 is supported by lift dolly 10 for rolling movement and transportation, downward force is exerted by an operator or user (preferably by the foot of the operator) on pedal 36 or a foot-receiving surface at the forward end of lever 38. Downward force may involve a single-stroke movement by the operator's foot.

The downward pivotal movement of lever 38 causes pivot shaft 18 housed within rear end frame member 16 to rotate about its axis. Crank arms 32 affixed to pivot shaft 18 are pivoted rearward by the rotational movement of pivot shaft 18 which accompanies downward movement of lever 38. Rear supporting element 26 is pivoted rearward by the rearward pulling motion of linking arms 30 causing the carriage region of support member 26 to follow an arcuate rearward and upward path. The rear end of object 50 is carried by support member 26 along the arcuate path and is thereby shifted rearward and lifted upward relative to castors 22.

As discussed above, in the illustrated embodiment of FIG. 1 an active operative connection is not established between support elements 24 and 26, at least when the frame structure is unoccupied by object 50. However, placement of object 50 on cradle elements 24, 26 establishes a latent connection between support elements 24 and 26 which allows elements 24, 26 to move in unison. Depressing lever 38 causes support element 26 to shift the rear end of object 50 rearward and to lift upward. Object 50 moves as a whole, unitary piece. Accordingly, the front end of object 50 likewise moves rearward as it is pulled by support element 26. Forward support element 24 on which the front end of object 50 is supported moves along an arcuate path, upward as it is pulled back due to its connection to object 50. The front portion of object 50 is thereby raised off the ground contemporaneously in synchronicity with the rear portion of object 50. In the raised position, support elements 24, 26 suspend object 50 and its legs 52 above the ground, with castor wheels 22 contacting the ground to carry the full weight of object 50 in a supporting manner above the ground. In this state, lift dolly 10 may wheel/transport object 50 across the ground to a desired location.

By setting crank arms 32 at an angle of approximately 15 degrees from vertical relative to when lift dolly 10 is in its lowered position, actuation of lever 38 causes support elements 24, 26 to raise the front and rear of object 50 coincidently and equally off the ground so that object 50 is maintained relatively level, and is primarily supported by castors 22 in the lifted position.

Dolly 10 is locked in its raised position as follows. The downward pivotal movement of lever 38 causes the curved outer surface of cam 43 to come into contact with retention pin 42. Continued downward movement causes the curved outer surface of cam 43 to slide along retention pin 42 as cam 43 rotates about pivot joint 49. The hooked-shaped portion of cam 43 is rotated (counterclockwise relative to FIG. 2) until retention pin 42 passes beyond the distal end of the hooked-shaped portion of cam 43. Retention pin 42 is thereby fully received in V-shaped groove of latch mount 40. When pedal 36 is released, the biasing force of spring 47 urges cam 43 into its initial position to capture retention rod 42 between the hook-shaped portion of cam 43 and the groove edge of latch mount 40. Dolly 10 is thereby locked in its raised position with object 50 supported above the ground.

In the illustrated embodiment, lift dolly 10 includes a height adjustment feature for selectively setting and controlling the distance that object 50 is spaced above the ground. The height adjustment feature may be consolidated into linking arms 30. For example, linking arms 30 may have an adjustable length for controlling the height object 50 is lifted. For example, if linking arms 30 comprise turnbuckles, the turnbuckle length may be adjusted by tightening or loosening the turnbuckles. According to an alternative embodiment described above, the height adjustment feature may reside in the employment of multiple locking positions between latch portions.

When it is desired to lower object 50 from its lifted position, the operator simply steps on surface/pedal 36 in order to release the latching mechanism. The downward force applied by the operator overcomes the biasing force of spring 47, causing cam 43 to rotate about pivot joint 49 and release retention rod 42 from its locked position. With pedal 36 depressed, the weight of object 50 causes support/cradle elements 24 and 26 to pivot downward to their original positions. Movement of cradle element 26 to its original position shifts linking arms 30 and crank arms 32 forward, which in turn rotates the pivoting shaft housed in rear end frame member 16 back to its original position. Rotation of the pivoting shaft causes lever 38 affixed thereto to pivot upward to the position shown in FIG. 2. The operator may regulate movement of object 50 to its lowered position by actively controlling lever 38.

In alternative embodiments, support elements 24 and 26 may feature an active connection which does not rely upon object 50 for establishing an operative connection between lever 38 and both of support elements 24, 26. For example, one or more horizontal links may operatively connect cradle element 26 to cradle element 24, so that lifting movements imparted by lever 38 are transmitted through the connecting links, instead of through the lifted object as in the illustrated embodiment. In this alternative embodiment, lowering of lever 38 will cause both support elements 24, 26 to move, irrespective of whether object 50 is loaded on support elements 24, 26.

Advantageously, the lift mechanism of the illustrated embodiment is relatively simply in design and function, easing maintenance requirements and reducing the effect of typical shop dust and debris on dolly lift 10. Additionally, dolly lift 10 is constructed and positioned relative to object 50 to permit safe and proper operation of object 50, e.g., a table saw, without requiring that object 50 be dismounted from dolly lift 10. Another advantage of the illustrated embodiment is the omni-directional mobility conferred by castors 22. Still another advantage of the illustrated embodiment is the height adjustability feature, which increases the compatibility of lift dolly 10 with various sized and shaped objects. Yet another advantage of the illustrated embodiment is the provision of the latent operative connection between support elements 24, 26, which is responsible for reducing the number of moving parts of lift dolly 10, thereby lessening expense and reducing the possibility of part malfunction. It should be understood that various modifications to the illustrated embodiment may be implemented within the scope of the invention, and that such modifications fall within the scope of the invention even though said modifications may eliminate or reduce one or more of these advantages.

The foregoing detailed description of the preferred embodiments of the invention has been provided for the purposes of illustration and description, and is not intended to be exhaustive or to limit the invention to the precise embodiments disclosed. The embodiments were chosen and described in order to best explain the principles of the invention and its practical application, thereby enabling others skilled in the art to understand the invention for various embodiments and with various modifications as are suited to the particular use contemplated. It is intended that the scope of the invention cover various modifications and equivalents.

What is claimed is:

1. A lift dolly for selectively lifting and transporting an object, comprising:
a frame structure comprising a wheel system;
movable supporting elements connected to said frame structure for lifting and lowering an object loaded on said supporting elements between a lowered position, in which the object rests on the ground, and a lifted position, in which the object is supported above the ground and movable by rolling said wheel system;
a foot-actuation member depressable downward in response to downward pressure applied to said foot-actuation member by a foot of an operator; and
an operative connection between said foot-actuation member and at least one of said support elements for moving said at least one of said supporting elements between the lowered and lifted positions in response to downward pressure applied to said foot-actuation member by the foot of the operator, said operative connection comprising a lever which pivots downward in response to the downward pressure applied to said foot-actuation member by the foot of the operator, a shaft which undergoes rotational movement as said lever pivots downward, and linking arms operatively connecting said shaft to said at least one of said supporting elements for moving said at least one supporting element between the lowered and lifted positions as said shaft rotates.

2. The lift dolly of claim 1, wherein said wheel system comprises a plurality of castors.

3. The lift dolly of claim 1, wherein said foot-actuation member is depressable by the foot of an operator in a single-stroke motion.

4. The lift dolly of claim 1, wherein said frame structure includes an open front area for unimpeded loading and unloading of the object on said supporting elements.

5. A method of lifting and transporting an object, comprising:
providing the lift dolly of claim 1;
loading an object on the lift dolly; and
applying a downward foot-activating motion to the foot-actuation member to move the supporting elements from the lowered position to the lifted position.

6. A lift dolly for selectively lifting and transporting an object, comprising:
a frame structure comprising a wheel system;
movable first and second supporting elements connected to said frame structure for lifting and lowering an object loaded on said supporting elements between a lowered position, in which the object rests on the ground, and a lifted position, in which the object is supported above the ground and movable by rolling said wheel system; and
an actuation member operatively connected to said first supporting element for moving said first supporting element from the lowered position to the lifted position, wherein said actuation member has a latent relationship with said second supporting element such that operative connection between said actuation member and said second supporting element is active when the object is loaded on said lift dolly, but inactive when said lifting dolly is unoccupied by the object.

7. The lift dolly of claim 6, wherein said wheel system comprises a plurality of castors.

8. The lift dolly of claim 6, wherein said actuation member is a foot-actuation member depressable by the foot of an operator.

9. The lift dolly of claim 6, wherein said actuation member is a foot-actuation member depressable by the foot of an operator in a single-stroke motion.

10. The lift dolly of claim 6, wherein said frame structure includes an open front area for unimpeded loading and unloading of the object on the supporting elements.

11. The lift dolly of claim 6, further comprising:
a lever operatively connected to said actuation member for pivoting downward in response to the downward pressure applied to said actuation member by the operator;
a shaft operatively connected to said lever to undergo rotational movement as said lever pivots downward; and
linking arms operatively connecting said shaft to at least one of said supporting elements for moving said at least one supporting element between the lowered and lifted positions as said shaft rotates.

12. A method of lifting and transporting an object, comprising:
providing the lift dolly of claim 6;
loading an object on the lift dolly; and
applying a downward foot-activating motion to the actuation member to move the supporting elements from the lowered position to the lifted position.

13. A lift dolly for selectively lifting and transporting an object, comprising:
a frame structure comprising a wheel system;
movable supporting elements connected to said frame structure for lifting and lowering an object loaded on said supporting elements between a lowered position, in which the object rests on the ground, and a lifted position, in which the object is supported above the ground and movable by rolling said wheel system;
an actuation member operatively connected to at least one of said supporting elements for moving said at least one of said supporting elements between the lowered and lifted positions in response to activation by an operator;
a locking mechanism for retaining said at least one of said supporting elements in the lifted position; and
a height adjustment feature for selectively setting the distance between the object and the ground when said locking mechanism retains said at least one of said supporting elements in the lifted position.

14. The lift dolly of claim 13, wherein said wheel system comprises a plurality of castors.

15. The lift dolly of claim 13, wherein said actuation member is a foot-actuation member depressable by the foot of an operator.

16. The lift dolly of claim 13, wherein said actuation member is a foot-actuation member depressable by the foot of an operator in a single-stroke motion.

17. The lift dolly of claim 13, further comprising:
a lever operatively connected to said actuation member for pivoting downward in response to the downward pressure applied to said actuation member by the operator;
a shaft operatively connected to said lever to undergo rotational movement as said lever pivots downward; and
linking arms operatively connecting said shaft to said at least one of said supporting elements for moving said at least one supporting element between the lowered and lifted positions as said shaft rotates.

18. The lift dolly of claim 13, further comprising:
a lever operatively connected to said actuation member for pivoting downward in response to the downward pressure applied to said actuation member by the operator; and
a shaft operatively connected to said lever to undergo rotational movement as said lever pivots downward,
wherein said height adjustment feature comprises linking arms operatively connecting said shaft to said at least one of said supporting elements for moving said at least one supporting element between the lowered and lifted positions as said shaft rotates.

19. A method of lifting and transporting an object, comprising:
providing the lift dolly of claim 13;
loading an object on the lift dolly; and
applying a downward foot-activating motion to the actuation member to move the supporting elements from the lowered position to the lifted position.

20. A lift dolly for selectively lifting and transporting an object, comprising:
a frame structure comprising a wheel system;
movable supporting elements connected to said frame structure for lifting and moving an object loaded on said supporting elements between a stationary lowered position, in which at least a portion of the weight of the object is not supported by the wheel system, and a lifted position, in which the object is supported above the ground and movable by rolling said wheel system;
an actuatable arm movable in response to pressure applied by an operator; and
an operative connection between said actuatable arm and at least one of the supporting elements for moving said at least one of the supporting elements between lowered and lifted positions in response to pressure applied to said arm by the operator, said operative connection comprising a lever which pivots downward in response to the downward pressure applied to said arm by the operator, a shaft which undergoes rotational movement as said lever pivots downward, and linking arms operatively connecting said shaft to said at least one of said supporting elements for moving said at least one supporting element between the lowered and lifted positions as said shaft rotates.
